(19) United States
(12) Patent Application Publication
(10) Pub. No.: US 2026/0362519 A1
(43) Pub. Date: Nov. 12, 2026

(54) SYSTEM AND METHOD FOR PAIRING A DASHCAM WITH A VEHICLE

(71) Applicant: GM GLOBAL TECHNOLOGY OPERATIONS LLC, Detroit, MI (US)

(72) Inventors: Alexander Bower, Ann Arbor, MI (US); Alec Johnson, The Villiages, FL (US); Alec M. Wuorinen, Columbus, OH (US); Matthew E. Gilbert-Eyres, Rochester Hills, MI (US); Philip Fu, San Jose, CA (US)

(73) Assignee: GM GLOBAL TECHNOLOGY OPERATIONS LLC, Detroit, MI (US)

(21) Appl. No.: 19/201,984

(22) Filed: May 8, 2025

(51) Int. Cl. H04W 76/14; H04W 4/021; H04W 12/63

(52) U.S. Cl. CPC H04W 76/14; H04W 4/021; H04W 12/63

(57) ABSTRACT

A method of pairing one of multiple vehicles with a dash camera. The method includes receiving at least one dash camera operating parameter for the dash camera and receiving at least one vehicle operating parameter for each of the vehicles. The method also includes identifying a matching vehicle from the vehicles based on the at least one vehicle operating parameter being within a predetermined range of a corresponding one of the at least one dash camera operating parameters. The method also includes updating a database to pair the matching vehicle with the dash camera when the at least one dash camera operating parameter is within the predetermined range of the corresponding one of the at least one operating parameter from the matching vehicle.

### BACKGROUND

The present disclosure relates to dash cameras, and more particularly, to a system and method that pairs a dash camera with a vehicle.

Dash cameras are becoming increasingly more popular in vehicles. While dash cameras have traditionally included a single camera located adjacent to a dash on a vehicle, dash cameras can include multiple cameras that provide an increased field of view surrounding the vehicle. In addition to capturing images, dash cameras can include a global positioning system (GPS) that tracks movement of the dash camera and can even collect audio recordings from inside the vehicle. The information collected by the dash camera can be stored on the dash camera and accessed at a later date if needed.

### SUMMARY

Disclosed herein is a method of pairing one of multiple vehicles with a dash camera. The method includes receiving at least one dash camera operating parameter for the dash camera and receiving at least one vehicle operating parameter for each of the vehicles. The method also includes identifying a matching vehicle from the vehicles based on the at least one vehicle operating parameter being within a predetermined range of a corresponding one of the at least one dash camera operating parameters. The method also includes updating a database to pair the matching vehicle with the dash camera when the at least one dash camera operating parameter is within the predetermined range of the corresponding one of the at least one operating parameter from the matching vehicle.

In one aspect of the disclosure the at least one dash camera operating parameter includes a dash camera global positioning system location and the at least one vehicle operating parameter includes a vehicle global positioning system location for each of the vehicles.

In one aspect of the disclosure the matching vehicle is identified when the dash camera global positioning system location is within a predetermined distance of the vehicle global position system location for the matching vehicle of the vehicles at a corresponding time.

In one aspect of the disclosure the at least one dash camera operating parameter includes a dash camera trip start time and the at least one vehicle operating parameter includes a vehicle trip start time and the matching vehicle is identified when a vehicle start time for one of the vehicles is within a predetermined length of time from the dash camera start time.

In one aspect of the disclosure the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed for a corresponding predetermined length of time.

In one aspect of the disclosure the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed at a corresponding time.

In one aspect of the disclosure the at least one dash camera operating parameter includes a dash camera visualization and the at least one vehicle operating parameter includes a vehicle visualization and the matching vehicle is identified when a corresponding object is identified in the dash camera visualization and the vehicle visualization within a predetermined length of time from each other.

In one aspect of the disclosure the object identified in the dash camera visualization and the object identified in the vehicle visualization are each identified utilizing a machine learning algorithm.

In one aspect of the disclosure updating the database to pair the matching vehicle with the dash camera includes linking a vehicle identification code corresponding to the matching vehicle with a dash camera identification code for the dash camera.

In one aspect of the disclosure updating the database to pair the matching vehicle with the dash camera includes transmitting a unique code the dash camera that is confirmed utilizing one of the matching vehicle or a mobile device.

In one aspect of the disclosure the at least one dash camera operating parameter includes a global positioning system location for the dash camera, the at least one vehicle operating parameter includes a global positioning system location for each of the vehicles, and the matching vehicle is identified when the dash camera global positioning system location is within a predetermined distance of the vehicle global position system location for the matching vehicle of the vehicles at a corresponding time.

In one aspect of the disclosure the at least one dash camera operating parameter includes a dash camera trip start time and the at least one vehicle operating parameter includes a vehicle trip start time and the matching vehicle is identified when a vehicle start time for one of the vehicles is within a predetermined length of time from the dash camera start time.

In one aspect of the disclosure the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed at a corresponding time.

In one aspect of the disclosure the at least one dash camera operating parameter includes a dash camera visualization and the at least one vehicle operating parameter includes a vehicle visualization and the matching vehicle is identified when a corresponding object is identified in the dash camera visualization and the vehicle visualization within a predetermined length of time from each other.

Disclosed herein is a non-transitory computer-readable storage medium embodying programmed instructions which, when executed by a processor, are operable for performing a method of pairing one of multiple vehicles with a dash camera. The method includes receiving at least one dash camera operating parameter for the dash camera and receiving at least one vehicle operating parameter for each of the vehicles. The method also includes identifying a matching vehicle from the vehicles based on the at least one vehicle operating parameter being within a predetermined range of a corresponding one of the at least one dash camera operating parameters. The method also includes updating a database to pair the matching vehicle with the dash camera when the at least one dash camera operating parameter is within the predetermined range of the corresponding one of the at least one operating parameter from the matching vehicle.

In one aspect of the disclosure the at least one dash camera operating parameter includes a global positioning system location for the dash camera and the at least one vehicle operating parameter includes a global positioning system location for each of the vehicles and the matching vehicle is identified when the global positioning system location for the dash camera is within a predetermined distance of the global position system location for the matching vehicle of the vehicles at a corresponding time.

In one aspect of the disclosure the at least one dash camera operating parameter includes a dash camera trip start time and the at least one vehicle operating parameter includes a vehicle trip start time and the matching vehicle is identified when a vehicle start time for one of the vehicles is within a predetermined length of time from the dash camera start time.

In one aspect of the disclosure the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed for a corresponding predetermined length of time.

In one aspect of the disclosure the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed at a corresponding time.

In one aspect of the disclosure the at least one dash camera operating parameter includes a dash camera visualization and the at least one vehicle operating parameter includes a vehicle visualization and the matching vehicle is identified when a corresponding object is identified in the dash camera visualization and the vehicle visualization within a predetermined length of time from each other.

Disclosed herein is a method of verifying a pairing between a dash camera and a matching vehicle. The method includes receiving at least one dash camera operating parameter for the dash camera and receiving at least one vehicle operating parameter for the matching vehicle. The method also includes determining if at least one vehicle operating parameter for the matching vehicle is within a predetermined range of a corresponding one of the at least one dash camera operating parameters. The method also includes updating a database to maintain the pairing or removing the pairing based on the at least one vehicle operating parameter for the matching vehicle being within the predetermined range of a corresponding one of the at least one dash camera operating parameters.

In one aspect of the disclosure the at least one dash camera operating parameter includes a dash camera global positioning system location, the at least one vehicle operating parameter includes a matching vehicle global positioning system location, and the matching vehicle is verified when the dash camera global positioning system location is within a predetermined distance of the matching vehicle global position system location at a corresponding time.

In one aspect of the disclosure the at least one dash camera operating parameter includes a dash camera trip start time and the at least one vehicle operating parameter includes a matching vehicle trip start time and the matching vehicle is verified when a matching vehicle trip start time is within a predetermined length of time from the dash camera start time.

In one aspect of the disclosure the at least one dash camera operating parameter includes a dash camera speed and the at least one vehicle operating parameter includes a matching vehicle speed and the matching vehicle is verified when the vehicle speed for the matching vehicle is within a predetermined speed range of the dash camera speed at a corresponding time.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates an example vehicle having at least one dash camera.

FIG. 2 is a flow chart of an example method of pairing the at least one dash camera of FIG. 1 to the vehicle of FIG. 1.

FIG. 3 is a first example graphical presentation of a speed(S) for both the vehicle and the at least one dash camera of FIG. 1 over time (t).

FIG. 4 is a second example graphical presentation of speed(S) for both the vehicle and the at least one dash camera of FIG. 1 over time (t).

FIG. 5 is a flow chart of an example method of performing a pairing verification between the vehicle and the at least one dash camera of FIG. 1.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

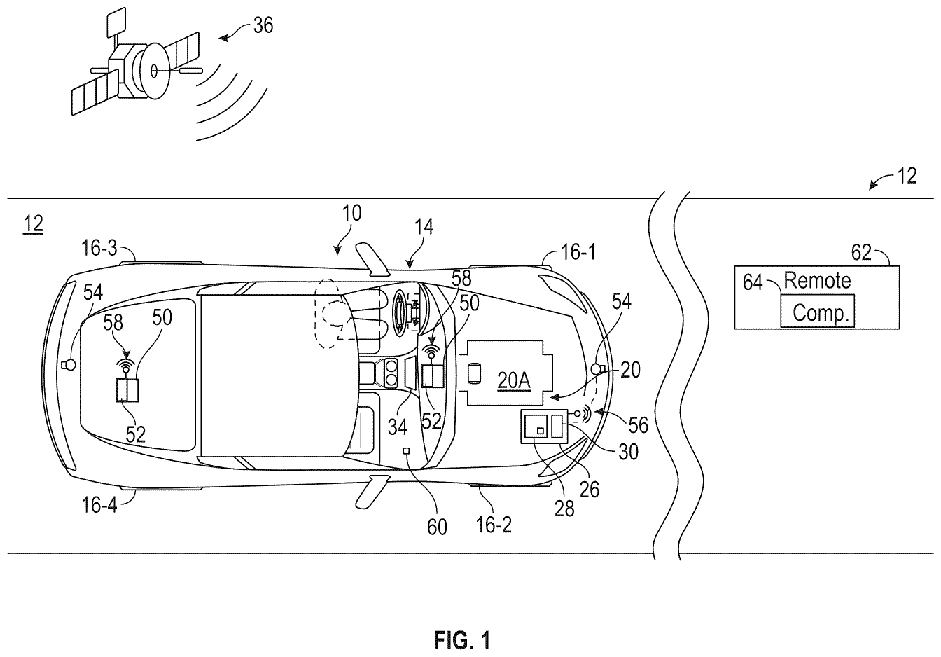

Referring to the FIGS., wherein like numerals indicate like parts referring to the drawings, wherein like reference numbers refer to like components, FIG. 1 shows a schematic view of a motor vehicle 10 positioned relative to a road surface, such as a vehicle lane 12. As shown in FIG. 1, the motor vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide fictional contact with the vehicle lane 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the vehicle lane 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators (for example, an electrical power steering unit) configured to steer the road wheels 16-1, 16-2, a steering angle, an accelerator device for controlling power output of the power-source(s) 20A, a braking switch or device for retarding rotation of the road wheels 16-1 and 16-2 (such as via individual friction brakes located at respective road wheels), etc.

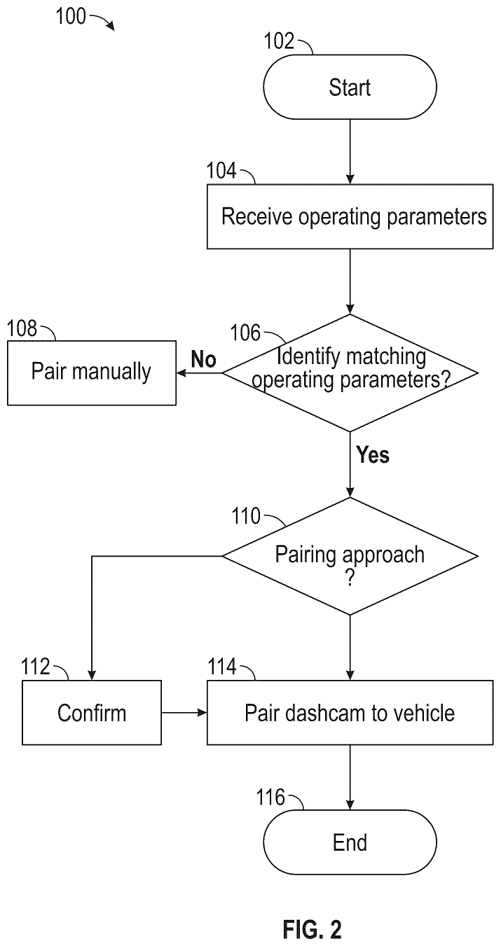

An electronic controller 26 is disposed in the motor vehicle 10 and may alternatively be referred to as a control module, a control unit, a controller, a vehicle controller, a computer, etc. The electronic controller 26 may include a computer and/or processor 28, and include software, hardware, memory, algorithms, connections, etc., for managing and controlling the operation of the motor vehicle 10. As such, a method, described below and generally represented in FIG. 2, may be embodied as a program or algorithm at least partially operable on the electronic controller 26.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory. The electronic controller 26 includes a tangible, non-transitory memory 30 on which computer-executable instructions, including one or more algorithms, are recorded for regulating operation of the motor vehicle 10.

The motor vehicle 10 also includes a vehicle navigation system 34, which may be part of integrated vehicle controls, or an add-on apparatus used to find travel direction in the vehicle. The vehicle navigation system 34 is also operatively connected to a global positioning system (GPS) 36 using an earth orbiting satellite. The electronic controller 26 is in communication with the GPS 36 via the vehicle navigation system 34. The vehicle navigation system 34 uses a satellite navigation device (not shown) to receive its position data from the GPS 36, which is then correlated to the vehicle's position relative to the surrounding geographical area. Based on such information, when directions to a specific waypoint are needed, routing to such a destination may be mapped and calculated. On-the-fly terrain and/or traffic information may be used to adjust the route. The current position of the motor vehicle 10 may be calculated via dead reckoning-by using a previously determined position and advancing that position based upon given or estimated speeds over elapsed time and course by way of discrete control points.

FIG. 2 illustrate a flow chart of an example method 100 of pairing the dash camera 50 to the vehicle 10. The method 100 begins at block 102 (“Start”) with the dash camera 50 installed into the vehicle 10 from FIG. 1 or another type of vehicle. In one example, a single dash camera 50 is installed into the vehicle 10 and in another example, at least two dash cameras 50 are installed into the vehicle 10. One feature of installing multiple dash cameras into the vehicle 10 is an increased field of view surrounding the vehicle 10.

The dash camera 50 can be installed into the vehicle by attaching it to a rigid structure, such as a windshield or dash, on the vehicle 10 that includes a field of view of an area surrounding the vehicle 10. The dash camera 50 can also be electrically connected to the vehicle 10 through a wired connection to the power outlet 60 on the vehicle 10. This allows the dash camera 50 to be fully powered by the vehicle 10 or to charge the battery pack in the dash camera 50 while the vehicle 10 is operational. With the dash camera 50 installed, the method 100 proceeds to block 104.

At block 104 (“Receive operating parameters”), the method 100 receives operating parameters from a dash camera 50 and multiple vehicles 10. In one example, the operating parameters are received by a computer 64 at the remote location 62. The computer 64 can include the components described above with respect to the electronic controller 26. The operating parameters can be grouped together to form a set of vehicles 10 that are associated with a predetermined account or a predetermined vehicle fleet for the given dash camera 50. For example, prior to pairing the given dash camera 50 to a corresponding or matching vehicle 10, the computer 64 includes a database identifying a group of vehicles 10 for a corresponding account associated with the given dash camera 50. One feature of this approach is to limit the number of vehicles for pairing with the dash camera 50.

In one example, the operating parameters include a GPS location for the dash camera 50 and the vehicles 10. In another example, the operating parameters include speeds with an associated time for the dash camera 50 and vehicles 10. In yet another example, the operating parameters include visualizations, such as still images or video, of an environment surrounding the vehicles 10 and the dash camera 50. The vehicle 10 can include at least one camera 54 for capturing images surrounding the vehicle 10.

One feature of this disclose is that the operating parameters from the vehicles 10 and the dash cameras 50 are communicated separately from each other to the computer 64 at the remote location 62. The vehicle 10 communicate through a wireless communication system 56 and the dash camera 50 communicates through a wireless communication system 58. The wireless communication systems 56 and 58 can include a cellular network or a satellite connection. This allows the remote location 62 to receive the operating parameters from each of the dash camera 50 and each of the vehicles 10 independent of their location or relationship with each other. With the operating parameters received, the method 100 then proceeds to block 106.

At block 106 (“Identify matching operating parameters”), the method 100 attempts to identify matching operating parameters between one of the dash cameras 50 and one of the vehicles 10. When the operating parameters includes GPS locations defined by GPS coordinates, a match between GPS coordinates for the vehicle 10 and the dash camera 50 is established when the GPS coordinates are within a predetermined distance of each other, such as within 3.3 feet (1 meter) of each other.

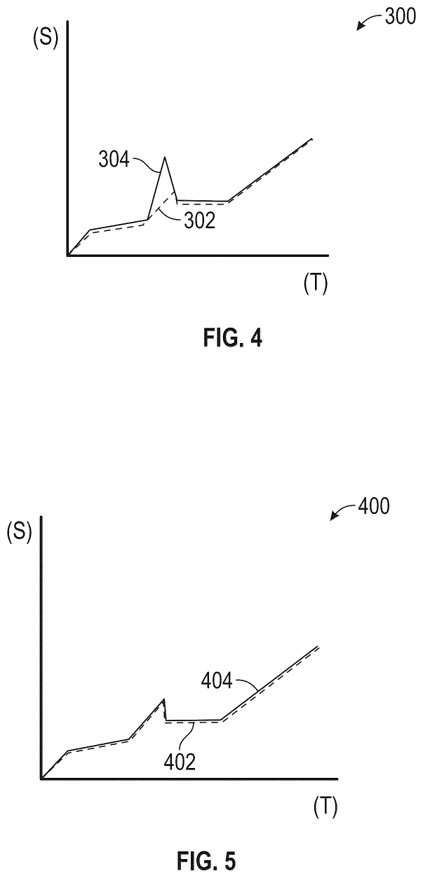

When the operating parameters includes speed and time, identifying a match between the vehicle 10 and the dash camera 50 is established when their speeds are within a predetermined speed of each other, such as within 2 miles per hour (MPH) (3.3 kilometers per hour (KPH)) for a predetermined length of time. In one example, a graphical representation 300 shown in FIG. 4 illustrates a relationship between speed(S) on the y-axis and time (t) on the x-axis. A first line 302 represents a speed of the vehicle 10 with respect to time and a second line 304 represents a speed of the dash camera 50 with respect to time. As shown in the graphical representation 300, there is a variation in speed shown by lines 302 and 304 indicating that there isn't a match between the given vehicle 10 and the dash camera 50 shown in the graphical representation 300.

Alternatively, a match between the speed for the vehicle 10 and the dash camera 50 is established when the vehicle 10 and the dash camera 50 each have a non-zero speed for a predetermined time period and the speed of the vehicle 10 and the dash camera 50 are each within a predetermined speed of each other. FIG. 5 illustrates a graphical representation 400 relationship between speed (S) on the y-axis and time (t) on the x-axis. A first line 402 represents a speed of the vehicle 10 with respect to time (t) and a second line 404 represents a speed of the dash camera 50 with respect to time (t). As shown in the graphical representation 400, the speed shown by lines 402 and 404 are within the predetermined speed of each other indicating a match for the given operating parameter.

When the operating parameters includes at least one of a trip start time or a trip end time for the dash camera 50 and each of the vehicles 10, a match between the start or end time for the vehicle 10 and the dash camera 50 is established when each time is within a predetermined time range of each other. The trip start time can be determined when the vehicle 10 or the dash camera 50 have been at a fixed location or have a speed of zero for a predetermined time and then begin to move. Conversely, the trip end time can be determined when the vehicle 10 and the dash camera 50 have been moving as determined by the GPS coordinates for a predetermined amount of time and are in a fixed location and have zero speed for predetermined length of time.

When the operating parameters include visualizations captured by the camera 54 on the vehicle 10 and the dash camera 50, a match between the images or video captured at a corresponding time by the vehicle 10 and the dash camera 50 is determined by comparing the images or video from each with a machine learning or artificial intelligence (AI) algorithm. The algorithm can identify a match utilizing a pixel-level comparison, feature extraction, a deep learning approach utilizing convolution neural networks, or through similarity metrics.

The method 100 can determine when a given vehicle 10 matches one of the dash camera 50 when a predetermined number of types of operating parameters as discussed above are identified as matching. In one example, the method 100 determines that the vehicle 10 and the dash camera 50 are a match when at least two matching types of operating parameters, such as GPS coordinates and speed. In another example, the method 100 determines that the vehicle 10 and the dash camera 50 are a match when at least three types of operating parameters match, such as GPS coordinates, speed, start time, or end time. In yet another example, the method 100 determines that the vehicle 10 and the dash camera 50 are a match when at least five types of operating parameters match, such as GPS coordinates, speed, start time, end time and image/video captured.

If the method 100 fails to establish the predetermined number of matching types of operating parameters, the method 100 can proceed to block 108 (“Pair manually”), and have the operator of the vehicle 10 and the dash camera 50 pair the two devices manually. If the method 100 establishes the predetermined number of matching types of operating parameters, the method 100 proceeds to block 110.

At block 110 (“Pairing approach”), the method 100 determines between pairing the vehicle 10 and the dash camera 50 semi-automatically or automatically. If the method 100 determines to pair the vehicle 10 and the dash camera 50 semi-automatically, the method 100 proceeds to block 112.

At block 112 (“Confirm”), the method 100 can utilize a confirmation to ensure that the operator of the vehicle 10 wants to pair it with the given dash camera 50. The confirmation can include the remote location 62 transmitting a unique code to display on a display 52 on the dash camera 50 in addition to or in place of a push notification to at least one of the vehicle 10 or a mobile device of the operator of vehicle 10 to confirm pairing of the vehicle 10 and the dash camera 50. If the operator confirms the pairing, the method 100 proceeds to block 114 and pairs the dash camera 50 to the vehicle 10 in the database at the remote location 62. The process of pairing the matching vehicle 10 to the dash camera 50 includes updating a database that creates a link between the dash camera 50 and the matching vehicle 10. In one example, updating the database includes linking a vehicle identification code corresponding to the matching vehicle 10 with a dash camera identification code for the dash camera 50. The method 100 can then proceed to block 116 (“End”) and end.

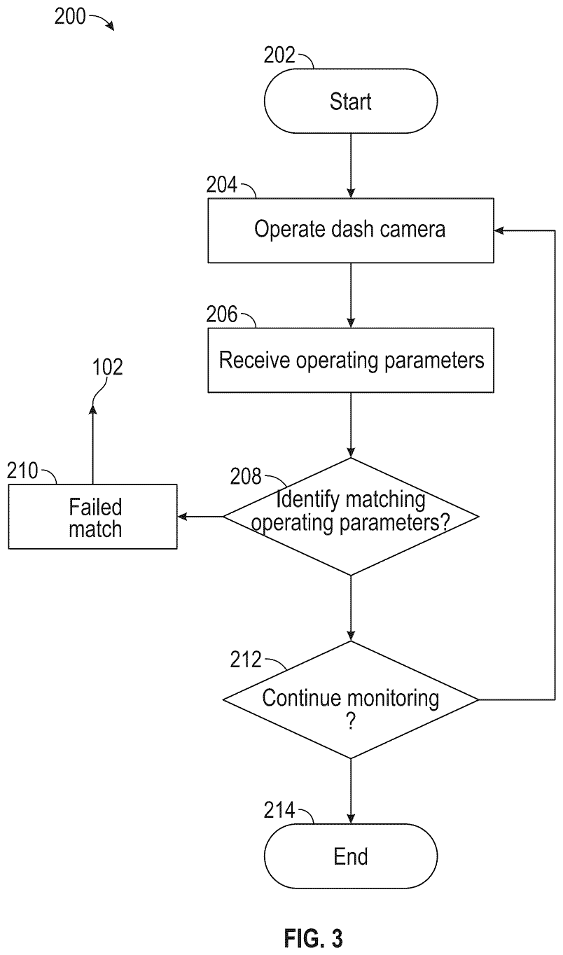

FIG. 3 illustrates a flow chart for an example method 200 of verifying the pairing between the vehicle 10 and the dash camera 50. The method 200 begins at block 202 (“Start”) and then proceeds to block 204. At block 204 (“Operate dash camera”), the dash camera 50 that was previously paired to one of the vehicles 10 is turned on and operated. Due to maintenance schedules and repairs, it is possible that the vehicle 10 that the dash camera 50 was originally paired with could be out of service and the dash camera 50 was placed into another vehicle 10, such as another vehicle within the same fleet. Once the dash camera 50 has been operated with a vehicle for a predetermined length or time, the method 200 proceeds to block 206.

At block 206 (“Receive operating parameters”), the method 200 receives operating parameters from the dash camera 50 and its corresponding paired vehicle 10 at the remote location 62 as described above with respect to block 104 of the method 100. In one example, the dash camera 50 and the vehicle 10 were previously paired using the method 100 described above, however, the dash camera 50 and the vehicle 10 could have been paired using an alternative method of pairing. Furthermore, the operating parameters received at block 206 can include the same types of operating parameters received above at block 104 for the method 100. With the operating parameters received, the method 200 then proceeds to block 208.

At block 208 (“Identify matching operating parameters”), the method 200 attempts to identify matching operating parameters between the dash cameras 50 and its corresponding paired vehicle 10. The method 200 can utilize the same criteria for identifying a match in the corresponding types of operating parameters as utilized in the method 100 at block 106. If the method 200 fails to identify a predetermined number of matchings types of operating parameters, the method 200 then proceeds to block 210.

At block 210 (“Failed Match”), the method 200 can notify the operator of the dash camera 50 that the dash camera 50 is not paired with the vehicle 10 where the dash camera 50 is operating. This notification can be displayed on the display 52 on the dash camera 50 or through a push notification to a mobile device an operator of the vehicle 10 that the dash camera 50 is located in or to a fleet manager for the vehicle 10 or dash camera 50. The method 200 can also return to block 102 of the method 100 to begin the pairing process for the dash camera 50 and the vehicle 10 if desired. If the method 200 identifies a predetermined number of matching types of operating parameters, the method 200 can proceed to block 212.

At block 212 (“Continue monitoring?”), the method 200 selects between continuing monitoring the dash camera 50 or ending. In one example, the method 200 makes the selection by sending a message to the operator of the dash camera 50 through a message on the display 52 of the dash camera 50 or through a push notification to a mobile device of the operator of the vehicle 10 requesting to continue or end the verification process of the method 200. If the method 200 receives a response requesting the method 200 to end, the method 200 proceeds to block 214 and ends. Alternatively, if the request is to continue the verification process, the method 200 returns to block 204 and continues through the method 200 again.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of pairing one of a plurality of vehicles with a dash camera, the method comprising:
receiving at least one dash camera operating parameter for the dash camera;
receiving at least one vehicle operating parameter for each of the plurality of vehicles;
identifying a matching vehicle from the plurality of vehicles based on the at least one vehicle operating parameter being within a predetermined range of a corresponding one of the at least one dash camera operating parameters; and
updating a database to pair the matching vehicle with the dash camera when the at least one dash camera operating parameter is within the predetermined range of the corresponding one of the at least one operating parameter from the matching vehicle.

2. The method of claim 1, wherein the at least one dash camera operating parameter includes a dash camera global positioning system location and the at least one vehicle operating parameter includes a vehicle global positioning system location for each of the plurality of vehicles.

3. The method of claim 2, wherein the matching vehicle is identified when the dash camera global positioning system location is within a predetermined distance of the vehicle global position system location for the matching vehicle of the plurality of vehicles at a corresponding time.

4. The method of claim 2, wherein the at least one dash camera operating parameter includes a dash camera trip start time and the at least one vehicle operating parameter includes a vehicle trip start time and the matching vehicle is identified when a vehicle start time for one of the plurality of vehicles is within a predetermined length of time from the dash camera start time.

5. The method of claim 2, wherein the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed for a corresponding predetermined length of time.

6. The method of claim 2, wherein the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed at a corresponding time.

7. The method of claim 1, wherein the at least one dash camera operating parameter includes a dash camera visualization and the at least one vehicle operating parameter includes a vehicle visualization and the matching vehicle is identified when a corresponding object is identified in the dash camera visualization and the vehicle visualization within a predetermined length of time from each other.

8. The method of claim 7, wherein the object identified in the dash camera visualization and the object identified in the vehicle visualization are each identified utilizing a machine learning algorithm.

9. The method of claim 1, wherein updating the database to pair the matching vehicle with the dash camera includes linking a vehicle identification code corresponding to the matching vehicle with a dash camera identification code for the dash camera.

10. The method of claim 1, wherein updating the database to pair the matching vehicle with the dash camera includes transmitting a unique code the dash camera that is confirmed utilizing one of the matching vehicle or a mobile device.

11. The method of claim 2, wherein:
the at least one dash camera operating parameter includes a global positioning system location for the dash camera, the at least one vehicle operating parameter includes a global positioning system location for each of the plurality of vehicles, and the matching vehicle is identified when the dash camera global positioning system location is within a predetermined distance of the vehicle global position system location for the matching vehicle of the plurality of vehicles at a corresponding time;
the at least one dash camera operating parameter includes a dash camera trip start time and the at least one vehicle operating parameter includes a vehicle trip start time and the matching vehicle is identified when a vehicle start time for one of the plurality of vehicles is within a predetermined length of time from the dash camera start time; and
the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed at a corresponding time.

12. The method of claim 11, wherein the at least one dash camera operating parameter includes a dash camera visualization and the at least one vehicle operating parameter includes a vehicle visualization and the matching vehicle is identified when a corresponding object is identified in the dash camera visualization and the vehicle visualization within a predetermined length of time from each other.

13. A non-transitory computer-readable storage medium embodying programmed instructions which, when executed by a processor, are operable for performing a method of pairing one of a plurality of vehicles with a dash camera, the method comprising:
receiving at least one dash camera operating parameter for the dash camera;
receiving at least one vehicle operating parameter for each of the plurality of vehicles;
identifying a matching vehicle from the plurality of vehicles based on the at least one vehicle operating parameter being within a predetermined range of a corresponding one of the at least one dash camera operating parameters; and
updating a database to pair the matching vehicle with the dash camera when the at least one dash camera operating parameter is within the predetermined range of the corresponding one of the at least one operating parameter from the matching vehicle.

14. The storage medium of claim 13, wherein the at least one dash camera operating parameter includes a global positioning system location for the dash camera and the at least one vehicle operating parameter includes a global positioning system location for each of the plurality of vehicles and the matching vehicle is identified when the global positioning system location for the dash camera is within a predetermined distance of the global position system location for the matching vehicle of the plurality of vehicles at a corresponding time.

15. The storage medium of claim 13, wherein the at least one dash camera operating parameter includes a dash camera trip start time and the at least one vehicle operating parameter includes a vehicle trip start time and the matching vehicle is identified when a vehicle start time for one of the plurality of vehicles is within a predetermined length of time from the dash camera start time.

16. The storage medium of claim 13, wherein the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed for a corresponding predetermined length of time.

17. The storage medium of claim 13, wherein the at least one dash camera operating parameter includes a dash camera speed and the at least one vehicle operating parameter includes a vehicle speed and the matching vehicle is identified when the vehicle speed for the matching vehicle is within a predetermined speed range of the dash camera speed at a corresponding time.

18. The storage medium of claim 13, wherein the at least one dash camera operating parameter includes a dash camera visualization and the at least one vehicle operating parameter includes a vehicle visualization and the matching vehicle is identified when a corresponding object is identified in the dash camera visualization and the vehicle visualization within a predetermined length of time from each other.

19. A method of verifying a pairing between a dash camera and a matching vehicle, the method comprising:
receiving at least one dash camera operating parameter for the dash camera;
receiving at least one vehicle operating parameter for the matching vehicle;
determining if at least one vehicle operating parameter for the matching vehicle is within a predetermined range of a corresponding one of the at least one dash camera operating parameters; and
updating a database to maintain the pairing or removing the pairing based on the at least one vehicle operating parameter for the matching vehicle being within the predetermined range of a corresponding one of the at least one dash camera operating parameters.

20. The method of claim 19, wherein:
wherein the at least one dash camera operating parameter includes a dash camera global positioning system location, the at least one vehicle operating parameter includes a matching vehicle global positioning system location, and the matching vehicle is verified when the dash camera global positioning system location is within a predetermined distance of the matching vehicle global position system location at a corresponding time;
the at least one dash camera operating parameter includes a dash camera trip start time and the at least one vehicle operating parameter includes a matching vehicle trip start time and the matching vehicle is verified when a matching vehicle trip start time is within a predetermined length of time from the dash camera start time; and
the at least one dash camera operating parameter includes a dash camera speed and the at least one vehicle operating parameter includes a matching vehicle speed and the matching vehicle is verified when the vehicle speed for the matching vehicle is within a predetermined speed range of the dash camera speed at a corresponding time.
